(19) United States
(12) Patent Application Publication
(10) Pub. No.: US 2001/0040348 A1
(43) Pub. Date: Nov. 15, 2001

(54) PIPE CONNECTING GASKETS

(76) Inventor: NORIATSU KOJIMA, NAGOYA-SHI (JP)

Correspondence Address: DOUGLAS J CHRISTENSEN, PATTERSON & KEOUGH, P.A., 4800 IDS CENTER, 80 SOUTH EIGHTH STREET, MINNEAPOLIS, MN, 55435

(21) Appl. No.: 09/197,100

(22) Filed: Nov. 20, 1998

(30) Foreign Application Priority Data
Nov. 20, 1997 (JP) 9-319899
Apr. 27, 1998 (JP) 10-117362
Jul. 17, 1998 (JP) 10-203420

(51) Int. Cl. H02G 15/013

(52) U.S. Cl. 277/602

(57) ABSTRACT

A gasket having a generally cylindrical shape is mounted between a side branch pipe and a; connection receiving inlet when inserting and connecting the side branch pipe 12 to the inner peripheral side of a connection receiving inlet of the pipe joint. At the periphery of the mounting rear end side, the gasket has a folded part 2 that is folded in a generally U shape to the outer peripheral side and that can sandwich the end part of the connection receiving inlet. A reinforcing member 3 also may be provided on the gasket. Thus, the gasket is prevented from being pushed in the inner part of the connection receiving inlet when inserting the side branch pipe.

### BACKGROUND OF THE INVENTION

1. Field of the Invention

The present invention relates to a pipe connecting gasket and an attaching structure that can be used, for example, to connect a side branch pipe to a drainpipe joint.

2. Description of the Related Art

Pipe connecting gaskets, including for example the one-touch type gasket disclosed in Japanese Utility Model publication No. 55-5833, have been well known. The one-touch gasket disclosed in this publication has a generally cylindrical shape and is used to connect one pipe that has been inserted into the inner peripheral side of another pipe.

For example, as shown in FIG. 11 in which a vertical drain pipe 21 is inserted in and connected to a connection inlet 22 of the vertical drain pipe joint, a one-touch gasket 20 is mounted between the inner peripheral side of the connection inlet 22 and the outer peripheral side of the vertical drain pipe 21. If handled properly, pipes can be securely connected together in a watertight condition by this one-touch gasket 20. Thus, the pipe connecting operation using such one-touch gaskets was an improvement as compared to conventional mechanical joints.

However, such known one-touch gaskets 20 have several problems. For example, when connecting the pipes, the known one-touch gasket 20 is positioned or mounted on the inner peripheral surface of the connection inlet 22 in advance. The flange part 20a integrally formed at the rear end side of the gasket mounting is made to contact only the end face of the connection inlet 22 and is made from a relatively soft rubber, as is the gasket body. Then, when inserting the pipe 21 into the inner peripheral side of the gasket 20, the flange part 20a deforms in accordance with the inserting operation of the pipe 21. As a result, the pipe can easily come off the connection receiving inlet end face and the gasket 20 may be pushed inside the pipe. Therefore, the connecting operation of the pipe 21 can very troublesome, because the operator must insert the pipe 21 while at the same time preventing positional slipping (insertion) of the gasket 20.

Especially in situations in which the pipe connecting direction is in the lateral direction, such as in a case in which a side branch pipe is connected to the side branch pipe connection receiving inlet (connection inlet) of a vertical pipe joint, one pipe (i.e. side branch pipe) is tilted to face the second pipe (i.e. the connection inlet of the pipe joint). Then, the side branch pipe is inserted into and thereby connected to the second pipe while gradually restoring the pipes to the horizontal position. However, in this case, the weight of one pipe causes the gasket mounted on the inner surface of the second pipe to slip or move.

Further, after the pipe 21 is connected, the gasket 20 will be removed with the connection inlet 22, if the pipe 21 must be removed from the connection inlet 22 for any reason, such as maintenance. Thus, when the pipes are re-connected, the same connection problems noted above will be encountered and a significant amount of time may be required to properly re-connect the pipes.

### SUMMARY OF THE INVENTION

Therefore, an object of the present invention is to provide an improved pipe connecting gasket that solves, or at least substantially minimizes, such problems with known pipe connecting gaskets.

Preferably, a pipe connecting gasket is taught that can be securely mounted so as not to slip from a desired position when connecting two pipes. More preferably, a pipe connecting gasket is taught having a generally cylindrical shape and is adapted to be mounted between two pipes when inserting and connecting one pipe to the inner peripheral side of another pipe. The gasket may have a flange part that projects to the outer peripheral side and abuts a connection receiving inlet end face of the second pipe on the periphery of the mounting rear end side. Further, the gasket may have a reinforcing member disposed to reinforce the flange part to thereby prevent the deformation of the flange part during a pipe connecting operation.

By including a reinforcing member in the gasket, deformation at the flange part is reduced in comparison to known gaskets. Therefore, positional slipping of the gasket when inserting one pipe into a second pipe can be prevented and thus the pipe connecting operation can be simplified. In addition, by reducing deformation at the flange part and preventing positional slipping of the gasket during the pipe connecting operation, an improved water-tight fit can be obtained over known gaskets.

A pipe connecting gasket is also taught in which a folded part is provided on the outer periphery of the flange part that projects to the mounting front end side and that can elastically engage the connection receiving end part of the second pipe. This gasket can be mounted on the inner peripheral side of the second pipe in a condition in which the folded part, the flange part and the gasket body form a channel that engages the connection receiving end part of the second pipe. Thereafter, when inserting one pipe into the inner peripheral side of the second pipe, the position of the gasket is more firmly held than that of a known gasket.

According to this arrangement, positional slipping of the gasket when inserting one pipe into a second pipe can be prevented, so that the pipe connecting operation can be further simplified. In addition, when removing a pipe that was connected with such a pipe connecting gasket, the gasket remains in place during the removal operation, because the position of the gasket is firmly held at the connection receiving inlet. Thus, maintenance operations, such as pipe replacement, can be easily performed. Further, by preventing positional slipping of the gasket when connecting two pipes, an improved water-tight fit can be obtained over known gaskets.

### BRIEF DESCRIPTION OF THE DRAWINGS

FIG. 1 is a view showing a first embodiment, wherein a gasket is shown in vertical section, one pipe is shown at side view, and the second pipe is shown in vertical sectional view;

FIG. 2 is a side view showing a piping example in which a toilet seat is connected to a vertical drainpipe joint via a side branch pipe;

FIG. 3 is a view showing a second embodiment, which is a partial sectional side view showing the mounted condition of a gasket in a condition where a side branch pipe is connected to a connection inlet of the vertical drainpipe joint,

FIG. 4 is an enlarged view of part IV of FIG. 3;

FIG. 5 is a view showing a third embodiment, which is a vertical sectional view of a connection receiving inlet of a drain pipe joint is connected to a side branch pipe;

FIG. 6 is a front view showing a gasket independent of a pipe;

FIG. 7 is a sectional view along line VII-VII of the gasket of FIG. 6 shown without a metallic cover;

FIG. 8 is a view showing a fourth embodiment, which is a vertical sectional view of a connection receiving inlet of a drain pipe joint in which a gasket is mounted and a side branch pipe is connected.

FIG. 9 is a vertical sectional view of the gasket of the fourth embodiment;

FIG. 10 is a vertical sectional view showing the mounted condition of the gasket of the fourth embodiment to a connection receiving inlet;

FIG. 11 is a partial sectional side view showing a vertical pipe connected to a connection inlet using a known gasket;

FIG. 12 is a side view of a piping example using a vertical drainpipe joint;

FIG. 13 is a view showing a fifth embodiment, which is a vertical view of area XIII of FIG. 12;

FIG. 14 is a detailed view of area XIV of FIG. 13, which is a vertical sectional view of the circumference of a gasket mounted on a connection receiving inlet; and

FIG. 15 is a vertical sectional view showing the gasket of the fifth embodiment independent from a pipe.

### DETAILED DESCRIPTION OF THE INVENTION

When using a gasket according to the present teachings, positional slipping of the gasket can be prevented when connecting two pipes by contacting the flange part of the gasket reinforced by the reinforcing member with the connection receiving inlet end face of the second pipe. In addition or in the alternative, a folded part can be provided that projects from the end of the flange part to form a channel that can engage the connection receiving inlet end face during the pipe connecting operation. Further, a stepped part optionally is provided on the gasket body. Thus, when removing one pipe from the second pipe, engagement of the stepped part of the gasket body with a stepped part provided on the inner peripheral surface of the connection receiving inlet of the second pipe in the removal direction prevents positional slipping of the gasket with respect to the second pipe. Thus, when both inserting and removing the pipe, positional slipping of such a gasket can be prevented. Thus, the pipe connecting operation and the pipe removal operation can be easily performed when maintenance or some other operation is necessary.

The reinforcing member may be attached at the flange part, at the folded part, or both parts in order to prevent deformation. In such a gasket, the folded part more firmly engages the connection receiving end part of the second pipe, because the reinforcing member prevents deformation at the folded part. Thus, positional slipping of the gasket with respect to the second pipe can be positively prevented.

The reinforcing member optionally can be made from a nonflammable material and may have an annular shape so as to cover the outer surfaces of the flange part and the folded part. In this case, the reinforcing member may also function as a nonflammable annular cover, so that positional slipping of the gasket is more securely prevented as mentioned above. Further, deterioration of the gasket due to aging can be suppressed (i.e., durability is improved) and the possibility that poisonous gasses may be released if the gasket is burned in a fire can be eliminated.

In a further alternative embodiment, the reinforcing member can be attached to the gasket after the gasket has been mounted on the second pipe. Thus, the reinforcing member can be pre-attached during the manufacturing stage or can be manufactured separately. If the reinforced member is detached from the gasket during assembly, the reinforcing member can be attached at the construction site at a time that is most convenient in view of the particular pipe connection operation. In this manner, the reinforcing function of the reinforcing member can be made more secure. The reinforcing member can be fixed to the gasket according to a variety of methods, including providing attaching points on the gasket as well as by adhesion, caulking, and curling, etc., or by providing an engaging part as described below.

To the contrary, the reinforcing member also can be pre-attached to the gasket, for example, by means of insertion-molding or monolithic-molding. A gasket of this type is useful when no need exists to perform the attaching operation of the reinforcing member (for example, a curling operation) at the construction site. In this case the pipe connecting operation can be simplified and improved without a fear that the reinforcing member will be lost. Therefore, parts management is simplified.

The reinforcing member also can be provided with an engaging part for connecting or latching the gasket to the reinforcing member. In this manner, the reinforcing member can be more firmly attached to the gasket. Preferably, an engaging hole with a small diameter, an engaging concave, an engaging claw, or such other types of engaging parts may be included in the reinforcing member. For example, in the case of the pre-attached type gasket discussed above, the gasket may be molded or formed to include such an engaging part, and preferably the reinforcing member is latched or connected in the removal direction on the gasket. Thus, the reinforcing member can be firmly fixed so as not to come off the gasket during a pipe removal operation. Also, in the case of the post-attached type gasket described herein, the reinforcing member can be firmly attached to the gasket by providing an engaging part, such as an engaging claw, for the reinforcing member.

An attaching structure may be provided to attach the above-mentioned gasket to the connection receiving inlet of the pipe joint. In this case, the flange part may be screwed onto the connection receiving inlet end face of the second pipe. With such an attaching structure, positional slipping of the gasket when connecting the pipe, as well as removal of the gasket when removing the pipe, can be more reliably prevented.

In the alternative, the attaching structure can be a stepped part that is fitted with the folded part on the opening outer peripheral surface of the connection receiving inlet to suppress the projection of the folded part from the outer peripheral surface of the connection receiving inlet. With such a gasket, the stepped part on the outer peripheral surface of the connection receiving inlet is formed with a sufficient depth (formed greater than the thickness of the folded part), so that the folded part can be made in a condition where the folded part does not project from the outer peripheral surface of the connection receiving inlet at all (the amount of projection is zero). By arranging the folded part so as not to project from the outer peripheral surface of the connection receiving inlet, the connection receiving inlet can be made closer to the upper surface of a concrete slab (the center height of the connection receiving inlet can be decreased), so that a sufficient inclination can be given to the side branch pipe.

Also, as mentioned above, it is most preferable that the folded part does not project from the outer peripheral surface of the connection receiving inlet at all. However, it is sufficient that the amount of projection of the folded part is minimized as necessary, which does not always need to be zero. If the amount of projection of the folded part is allowed to some degree (in a range less than the thickness of the folded part) and the depth at the stepped part of the connection receiving inlet is decreased, the thickness of the connection receiving inlet can be more secured accordingly. Thus, the strength at the connection receiving inlet can be increased.

For the purpose of this specification, the term “projection minimizing” means that the size of projection of the folded part from the outer periphery of the connection receiving inlet is less than the thickness of the folded part or zero. Preferably, the thickness of the folded part is at least 0.2 mm, and in this case, the stepped part of the outer peripheral surface of the connection receiving inlet is sufficient if it is provided with a slight depth. More preferably, the depth of the stepped part is made equal to or greater than the thickness of the folded part, so that the folded part does not project from at least the outer peripheral surface of the connection receiving inlet.

In the attaching structure according to the present teachings, in addition to the above effects and advantages, the finished appearance is attractive, and also, positional slipping or removal of the mounted gasket can be prevented in the event that members or other objects catch on the folded part when working on the pipes.

A pipe connecting gasket having a generally cylindrical shape and adapted to be mounted between two pipes when inserting and connecting one pipe to the inner peripheral side of another pipe also may include a packing body. A reinforcing member may be provided to project to the outer peripheral side of the mounting rear end side of the gasket body, and to abut the connection receiving inlet end face of the second pipe so as to prevent the gasket body from being pushed in when connecting the pipes. Because this pipe connecting gasket may be mounted in a condition in which the reinforcing member abuts the connection receiving inlet end face of the second pipe, the gasket does not move further to the inner side of the connection receiving inlet. Therefore, even if a great insertion resistance occurs when connecting the pipe, the reinforcing member will absorb the resistance, so that the gasket will not be pushed inside of the second pipe together with the inserted pipe. Thus, with the pipe connecting gasket according to this embodiment even if a lubricant, etc., is not applied to the inner peripheral surface of the gasket or the outer peripheral surface of the pipe before connecting pipes, the pipes can be connected while holding the gasket at a desired position.

The reinforcing member may be manufactured from a variety of materials, including for example, metal, synthetic resin, wood, and ceramics. Most preferably, the reinforcing member is manufactured from a material that has enough rigidity to absorb the insertion force in accordance with the pipe insertion without deformation when connecting the pipes.

Also, various methods can be utilized for the connecting the pipes using the reinforcing member. Such methods include a method in which the reinforcing member is caulked and fixed, a method in which the member is fixed by hanging a claw provided on the member, a method in which the member is fastened with machine screws, a method in which the member is insertion molded on the gasket body when forming the gasket, a method in which the member is monolithic molded on the gasket body, and a method in which the member is adhered on the gasket. Naturally, other methods may be utilized as appropriate.

Preferably, the reinforcing member is shaped as a flange to project to the outer peripheral side around the entire periphery of the gasket body. This reinforcing member can thus be provided in the form of a flange that abuts the entire periphery of the connection receiving inlet. As a result, a great insertion force can be utilized to secure the gasket relative to the pipes.

In addition, the reinforcing member may be formed to partially project, for example, at three equally-divided positions, at four equally-divided positions, or at other equally-divided positions in the peripheral direction. However, in some circumstances, the positions are not required to be equally divided or separated.

Also, the reinforcing member is not required to project in the form of a plate. For example, it can be arranged so that a bar is provided to project to the outer peripheral side with proper spacing in the peripheral direction and can be used like a hook to abut the connection receiving inlet end face and thereby prevent the gasket from being pushed into the pipe.

Preferably, a buffer member for preventing noise is inserted between the gasket and the connection receiving inlet end face, and the reinforcing member abuts the connection receiving inlet end face. Noise that typically occurs when the reinforcing member directly abuts the connection receiving inlet end face can be prevented.

A pipe connecting gasket having a generally cylindrical shape and adapted to be mounted between two pipes when inserting and connecting one pipe to the second pipe is also taught in which the gasket has an integrally formed edge for preventing the gasket from being pushed into the pipe. This edge may be reinforced by a reinforcing member so as to project to the outer peripheral side and thus the edge can abut and engage a first stepped part provided at the inner peripheral side of the second pipe in the insertion direction.

Because this pipe connecting gasket is mounted in a condition in which the edge abuts the first stepped part provided at the inner peripheral side of the connection receiving inlet of the second pipe, the gasket cannot move further to the inner side of the connection receiving inlet. By reinforcing the edge with the reinforcing member, even if a great insertion resistance occurs when inserting the first pipe, this insertion resistance can be absorbed by the reinforcing member. Therefore, the gasket will not be pushed inside of the second pipe together with the one pipe. Thus, according to the pipe connecting gasket discussed above, even if a lubricant is not applied on the inner peripheral surface of the gasket or the outer peripheral surface of the pipe to connect in advance, the pipe can be connected while holding the gasket at a prescribed position.

Moreover, with the arrangement according to the present teachings, the reinforcing member abuts the first stepped part provided at the inner peripheral side of the connection receiving inlet. Therefore, the end face of the gasket can be adjusted to the end face of the connection receiving inlet, or can be positioned at the inner part rather than the connection receiving inlet end face, so that the gasket can be mounted without projecting from the connection receiving inlet. In this case, although such a type of gasket is normally supplied to distributors or contractors in a condition in which the gasket is mounted on the connection receiving inlet of the pipe joint in advance, according to the arrangement discussed above, because the gasket can be mounted in a condition where the gasket does not project from the connection receiving inlet at all. Therefore, in the distribution stage or when being constructed, damage or unintended removal of the gasket due to interference by other objects can be prevented.

In this regard, when the edge for preventing the gasket from being pushed into the pipe (“the insertion prevention edge”) is arranged to abut the connection receiving inlet end face, for example, the insertion prevention edge projects from the connection receiving inlet. As a result, damage to the insertion prevention edge and positional slipping and removal of the gasket due to the interference of members, etc., can be prevented.

Further, the reinforcing member can be shaped as a flat plate or the reinforcing member can be shaped, for example, as a ring with the L-shape bent section, so that the rigidity of not only the reinforcing member, but also the insertion prevention edge, can be increased.

Preferably, on the outer peripheral surface of the gasket body, a removal prevention stepped part is provided to engage a second stepped part provided on the inner peripheral surface of the connection receiving inlet of the second pipe in a removal direction. Accordingly, when connecting the pipes, the insertion of the gasket is prevented by the engagement of the insertion prevention edge with the first stepped part provided on the inner peripheral surface of the connection receiving inlet of the second pipe. When removing one pipe from the other pipe, the insertion of the gasket is prevented by the engagement of the removal prevention stepped part with the second stepped part provided on the inner peripheral surface of the connection receiving inlet of the second pipe in the removal direction. Thus, when both inserting and removing the pipe, positional slipping of the gasket is prevented. As a result, both the pipe connecting operation and the pipe removing operation when performing maintenance can be easily performed.

Each of the additional features and method steps disclosed above and below may be utilized separately or in conjunction with other features and method steps to provide improved pipe connecting gaskets and methods for making and using the same. Representative examples of the present invention, which examples utilize many of these additional features and method steps in conjunction, will now be described in detail with reference to the drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detail description may not be necessary to practice the invention in the broadest sense, and are instead taught merely to particularly describe representative and preferred embodiments of the invention.

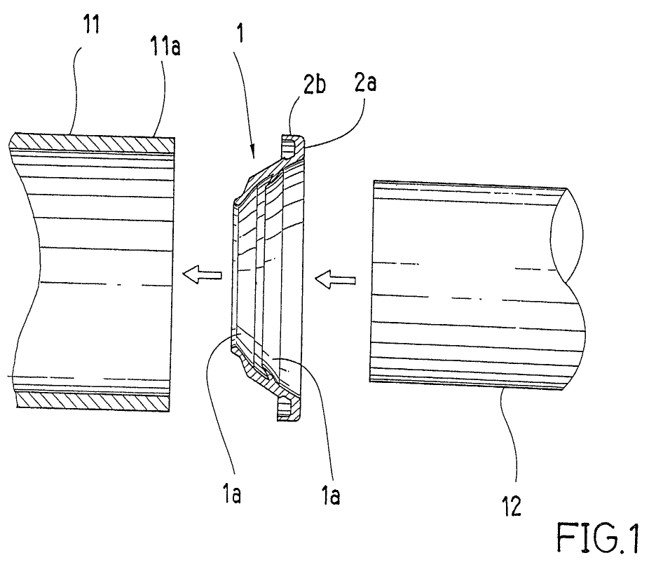

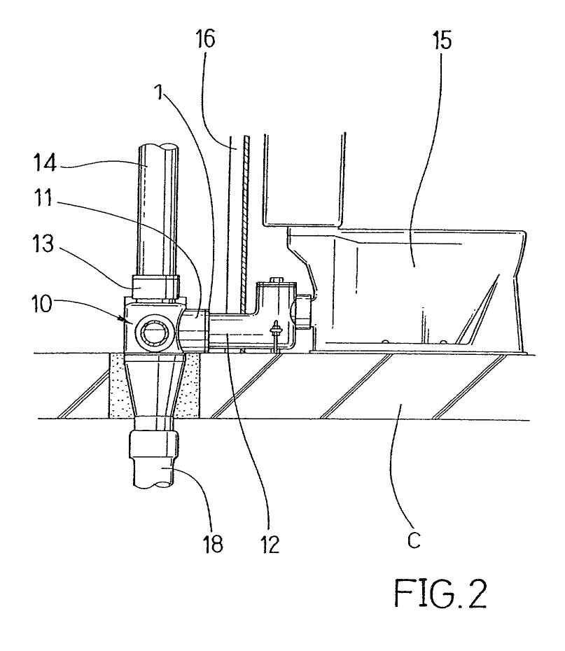

Thus, preferred embodiments of the invention will now be described with reference to FIGS. 1 to 10 and 12 to 15. In FIG. 1, a principal (first) embodiment of the presently taught gaskets is shown. A pipe 11 to which the gasket 1 is mounted on an inner surface thereof and a pipe 12 to be inserted into the inner peripheral side of the gasket 1 are shown prior to being the gasket being mounted in pipe 11 and prior to inserting pipe 12 into pipe 11. Although the pipes 11 and 12 are not described in detail because no special modification is required, pipe 11 is, for example, a side branch pipe connecting inlet of a vertical drainpipe joint 10 as shown in FIG.2, that corresponds to the second pipe in order to receive the connection. Pipe 12 is, for example, a side branch pipe to be connected to the side branch pipe connecting inlet 11 of the pipe joint 10. Needless to say, pipe 11 has a larger diameter than pipe 12. Also, in FIG. 2, numeral 15 is a toilet seat, numeral 16 is a wall face, symbol C is a concrete slab that separates an upper floor from a lower floor, and numeral 18 is a vertical drainpipe on a downstream side.

As shown in FIG. 1, the gasket 1 preferably is made from a rubber or other related resin material, such as a synthetic polymer material, with appropriate elasticity for such pipe connection applications and is monolithic-molded to have a generally cylindrical shape so that the mounting front end side (the left end side as viewed in the FIG. 1) is tapered. Most preferably, the gaskets are made of ethylene propylene rubber that has physical properties defined by JIS (Japanese Industrial Standards) K6380, AB6463. On the inner peripheral surface, two annular tongue-like pieces 1a preferably are formed so as to project around the entire periphery of the inner peripheral surface.

As shown in FIG. 2, when the side branch pipe 12 is connected to the connection inlet 11 of the vertical pipe joint 10 with a slight spacing from the upper surface of the concrete slab C by using such a cylindrical shaped gasket (one-touch gasket), the insertion of the side branch pipe 12 into the inner peripheral side can be performed with a relatively small force. On the other hand, removing the inserted side branch pipe 12 requires a much greater force. In other words, a large pipe binding force can be obtained with a small pipe inserting force, so that the pipe connecting operation becomes easy, and the connected pipe will not unexpectedly come off due to vibration, etc.

On the mounting rear end side of the gasket 1 of the first embodiment (the right most edge as viewed in FIG. 1), a flange part 2a is formed around the entire periphery of the gasket body and projects outwardly from the peripheral edge of the gasket body. A folded part 2b is formed extending from the outer periphery of the flange part 2a around the entire periphery and projects toward the mounting front end side. This gasket 1 is pushed into the inner peripheral side of the connection receiving inlet while being deformed by manual operation of an operator, and thereafter, the deformed gasket is restored to its original condition for easy mounting. When gasket 1 is mounted, the flange part 2a preferably abuts the end face of the connection receiving inlet 11a, and the folded part 2b presses against the outer peripheral surface of the connection receiving inlet 11a due to its elasticity.

Therefore, in a mounted condition in relation to pipe 11, the flange part 2a abuts the connection receiving inlet end face, and the folded part 2b is elastically presses against the outer peripheral surface around the entire periphery of the connection receiving inlet 11a, so that the gasket 1 elastically engages the connection receiving inlet 11a of the pipe 11. Thus, after the gasket 1 is mounted within pipe 11, pipe 12 can be inserted into the inner peripheral side of the gasket 1 and thereby connected to the pipe 11. Because the gasket 1 will not be pushed into the inside of pipe 11 when inserting pipe 12 into pipe 11, the gasket 1 is reliably held or fixed at the original prescribed mounting position throughout the pipe connecting operation. As a result, the operator can insert pipe 12 without worrying about positional slipping of the gasket 1, so that the operator can easily and reliably perform the pipe connecting operation.

Also, because of the elastic engaging action of the folded part 2b, the position of the gasket 1 never slips and is held at the prescribed mounting position. Therefore, when removing pipe 12 from pipe 11 for maintenance, for example, the gasket 1 is not removed with pipe 11 as a result of removal of pipe 12. Thus, difficulties arising from reconnecting pipes using known gaskets can be eliminated. Therefore, pipes can be more easily maintained when using pipes of the present invention.

Throughout the specification, the term “flange part” or “flange portion” can be defined as a shoulder that is formed around a peripheral edge of the gasket body. This flange part preferably abuts against the outer peripheral edge of the connection inlet of a pipe. Thus, the flange part can function to prevent the gasket from being pushed into the connecting inlet during a pipe connecting operation. Preferably, this flange part extends continuously around the peripheral edge of the gasket and projects outwardly from the gasket body at approximately a 90 degree angle. The term “flange part” can be used interchangeably with terms such as shoulder, ridge and means for abutting a terminal edge of a pipe connection inlet.

The term “folded part” or “folded portion” can be defined as a projection that extends or projects from the outer edge of the flange part. Preferably, the folded portion extends around the periphery of the flange part and projects towards the side of the gasket that is inserted into the connection inlet of a pipe at approximately a 90 degree angle. Thus, the folded portion can function, together with the flange part and the gasket body, to form a channel that engages the connection inlet of a pipe and can reliably hold the gasket in a desired position throughout a pipe connecting operation. In addition, this channel structure permits the gasket to be retained within the second pipe when the first pipe is removed, for example, for maintenance. Thus, these structures preferably permit gaskets of the present teachings to be securely fit within the connection inlet of a first pipe so that the gasket does not move or slip when a second pipe is inserted into or removed from the first pipe. The term “folded part” can be used interchangeably with terms such as projection, lip and means for securely holding the gasket to a pipe connection inlet.

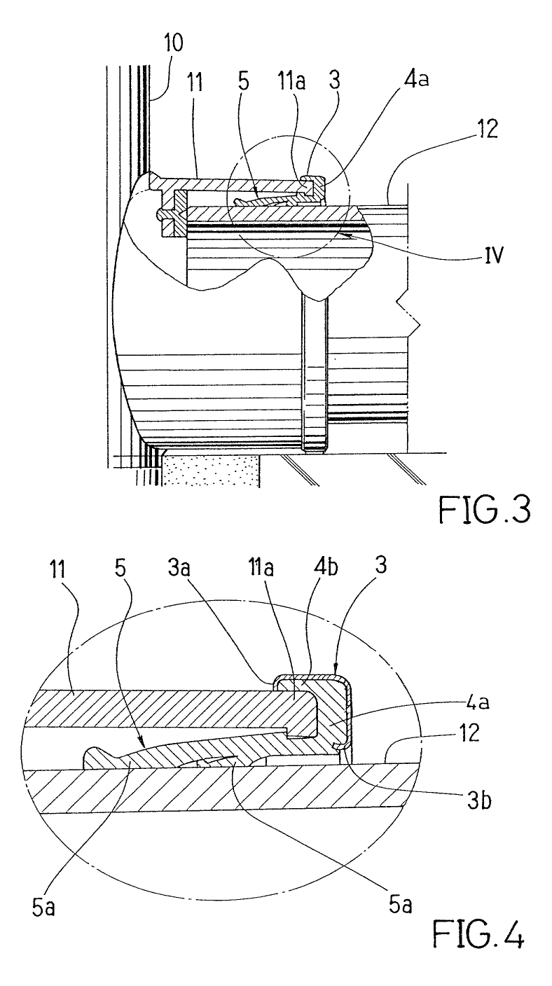

FIGS. 3 and 4 show a gasket 5 of a second embodiment that includes a reinforcing member 3 attached along the outer surfaces of a flange part 4a and a folded part 4b. This gasket 5 preferably has the same generally cylindrical shape as the gasket 1 of the first embodiment, and also has two annular tongue-like pieces 5a on the inner peripheral surface of the gasket body. The flange part 4a of the gasket 5 preferably abuts the end face or terminal edge of the connection receiving inlet 11a, and the folded part 4b elastically presses against the outer peripheral surface of the connection receiving inlet 11a to reliably engage the connection receiving inlet 11a.

In the case of this second embodiment, the reinforcing member 3 preferably is made from metal or some other resilient material. The reinforcing member 3 also may be shaped annularly and have a generally L-shape in cross-section. Preferably, the reinforcing member extends over both the outer surfaces of the flange part 4a and the folded part 4b so as to cover the entire periphery of those two parts. The reinforcing member 3 may be attached after the gasket 5 is mounted on the inner surface side of the connection receiving inlet 11a and the folded part 4b and can be fixed by curling the outer peripheral side end part 3a and the inner peripheral side end part 3b around the entire periphery.

If a reinforcing member 3 is attached in this manner, the flange part 4a and the folded part 4b do not deform. Therefore, the flange part 4a and the folded part 4b can be reliably secured to the connection receiving inlet 11a so that the pipe binding force is increased. As a result, gasket 5 will not be pushed into pipe 11 when pipe 12 is inserted and gasket 5 will not be removed or separated from pipe 11 when pipe 12 is disconnected from pipe 11.

Also, this reinforcing member 3 can function to minimize the exposure of the gasket body after pipe 12 has been connected. Therefore, deterioration due to aging of the gasket 5 can be suppressed. Further, in the event of a fire, gasket 5 is not likely to bum and thus, the occurrence of poisonous gasses is prevented.

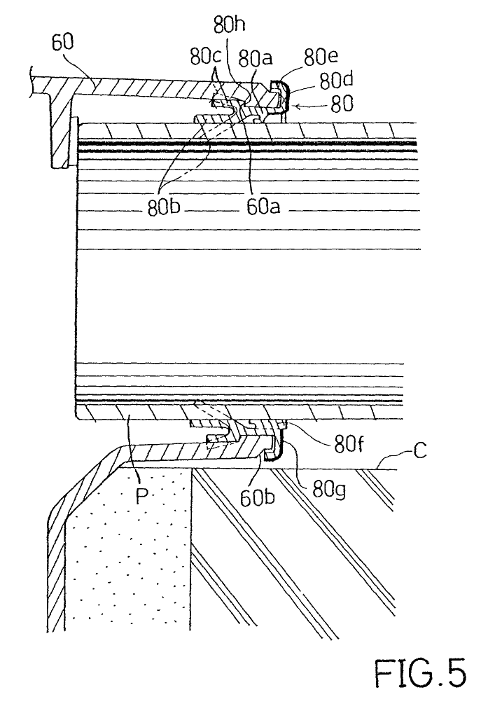

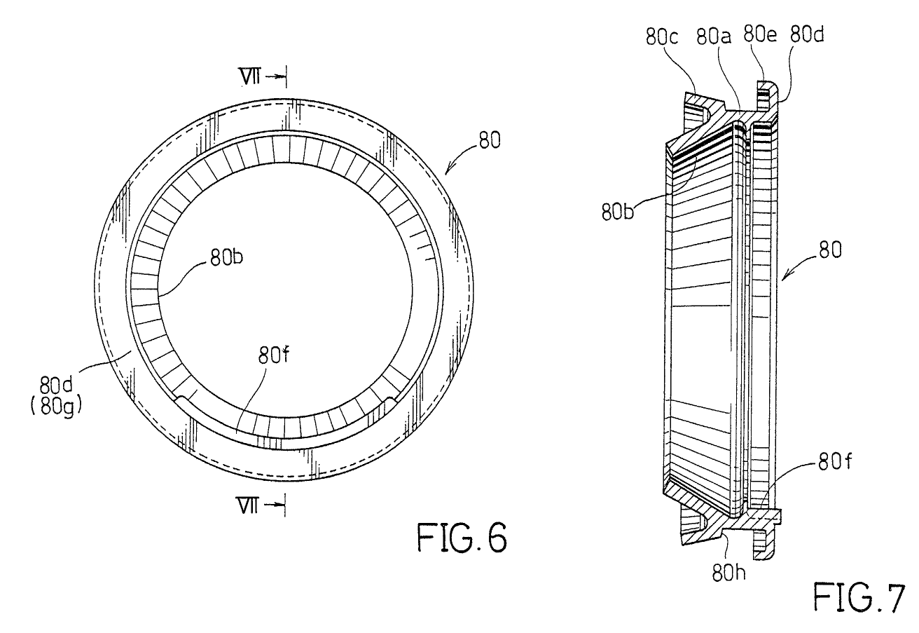

FIGS. 5 through 7 show a third embodiment of the invention in which an attaching structure of the gasket that can be used to connect the side branch pipe to a connection receiving inlet of a drainpipe joint is illustrated. In FIG. 5, numeral 60 is a connection receiving inlet for a side branch pipe connection provided at the side part of a drainpipe joint. The gasket 80 having a generally cylindrical shape is mounted on the inner peripheral side, and a side branch pipe P is inserted to the inner peripheral side of the gasket 80. FIGS. 6 and 7 show the gasket 80 separately from the pipes and the attaching structure.

Connection receiving inlet 60 has a terminal edge for abutting the gasket 80, and in particular for abutting the flange or shoulder 80d and the folded part or projection 80e. Preferably, an outer peripheral stepped part 60b is formed around the entire periphery of the terminal edge of the connection receiving inlet 60. More preferably, the front end side of the outer peripheral stepped part 60b is tapered. Also, an inner peripheral stepped part 60a is formed around the entire periphery of the inner surface of the connection receiving inlet 60 and preferably the front end side of inner peripheral stepped part is tapered. As a result, the terminal edge of the connection receiving inlet 60 has generally a crank-shaft shape in cross-section.

The gasket 80 has a ring-shaped opening part 80a to be mounted on the inner periphery of the opening of the connection receiving inlet 60, and has an integrally formed annular tongue piece 80b that preferably projects diagonally towards the inner peripheral side. Further, an engaging tongue piece 80c is preferably formed to project diagonally towards the outer peripheral side at the inner side end part (mounting front end side) of the opening part 80a. The side branch pipe P is inserted in the inner part of the connection receiving inlet 60 while pressing and expanding the annular tongue piece 80b, so that the annular tongue piece 80b adheres to the outer peripheral surface of the connected side branch pipe P to secure the seal of the two pipes. Also, the engaging tongue piece 80c adheres to the inner peripheral surface of the connection receiving inlet 60 by means of its own elasticity, so that a secure seal between the gasket 80 and the connection receiving inlet 60 is formed. Preferably, the inner peripheral surface of the connection receiving inlet 60 has a gradually tapered shape.

A stepped part 80h also may be formed on the outer peripheral surface at the base side of the engaging tongue piece 80c. The stepped part 80h can engage the inner peripheral stepped part 60a of the connection receiving inlet 60 in order to prevent the gasket 80 from being removed from side branch pipe P when the side branch pipe P is removed from the connection receiving inlet 60. Thus, this optional stepped part 80h can provide another advantageous feature.

As was previously described with respect to the first two embodiments, a flange part 80d can be formed on the end part at the mounting rear end side of the opening part 80a of the gasket 80. Preferably, the flange part 80d projects around the entire periphery to the outer peripheral side. A folded part 80e also can be integrally formed to project or extend from the periphery of the outer edge of flange part 80d.

Thus, as described above, when gasket 80 is mounted, the flange part 80d abuts the opening end face of the connection receiving inlet 60, so that gasket 80 does not slip or dislodge when inserting the drainpipe P. Also, the folded part 80e elastically presses against the outer peripheral stepped part 60b of the connection receiving inlet 60, so that the folded part 80e elastically engages the end part (outer peripheral stepped part 60b) of the connection receiving inlet 60 between the part 80e and the opening part 80a to prevent the gasket from unexpectedly coming off.

In this case, the folded part 80e of the gasket 80 is positioned at and fitted into the outer peripheral stepped part 60b of the connection receiving inlet 60, so that the outer peripheral surface of the connection receiving inlet 60 and the outer peripheral surface of the folded part 80e are even. Therefore, the depth of the outer peripheral stepped part 60b of the connection receiving inlet 60 is set to be the same size as the thickness of the folded part 80e.

Preferably, a thickened bolster 80f is provided at the opening lower part of the gasket 80. This bolster 80f is formed to slightly project towards the inner peripheral side at approximately 90 degrees as shown in FIG. 6. When the pipes are connected, the bolster 80f abuts the side branch pipe P, so that the position of the side branch pipe P can be concentrically held with the gasket 80. As a result, the sealing performance of the gasket 80 can be maintained for a long period of time. In other words, the dimensions of each part of the bolster 80f are set such that the position of the connected side branch pipe P can be concentrically held with the gasket 80. In FIG. 6, an arc-shaped bolster 80f is illustrated. However, bolster 80f can be formed in variety of shapes such as, for example, a flat surface (chord against the arc).

Again, as noted in the previous embodiments, a metallic cover or reinforcing member 80g can be attached to the outer surfaces of the flange part 80d and the folded part 80e. This reinforcing piece will provide the advantageous features noted above.

According to the attaching structure arranged in the above manner, because the folded part 80e elastically engages the opening of the connection receiving inlet 60, unexpected removal of the gasket and leakage of water can be prevented. Further, because the folded part 80e of the gasket 80 can be fitted into the outer peripheral stepped part 60b of the connection receiving inlet 60 and thus does not project from the outer peripheral surface of the connection receiving inlet 60, gasket 80 is not likely to be dislodged by contact with tools or other objects during the pipe connecting operation.

Because the folded part 80e does not project from the outer peripheral surface of the connection receiving inlet 60, compared to its projected case, the connection receiving inlet 60 can be made closer to the upper surface of the concrete slab C, so that the center height of the connection receiving inlet 60 is set lower to give a sufficient piping inclination to the side branch pipe P to connect. Further, because the folded part 80e of the gasket 80 does not project from the outer peripheral surface of the connection receiving inlet 60, the external appearance will be improved.

Also, the depth of the outer peripheral stepped part 60b can be formed to be less than the thickness of the folded part 80e, so that only a part of the folded part 80e in the thickness direction may be arranged to fit into the outer peripheral stepped part 60b. In this case, because the projected amount of the folded part 80e is not zero, as mentioned above, but less than its thickness, the center height of the connection receiving inlet 60 can be set lower accordingly.

The gasket 80 can be latched to the inner peripheral side stepped part 60a of the connection receiving inlet in the removal direction by the engagement of stepped part 80h. Therefore, the folded part 80e does not always need to be adhered (pressed) on the bottom surface of the outer peripheral stepped part 60b, which may be away from the bottom surface.

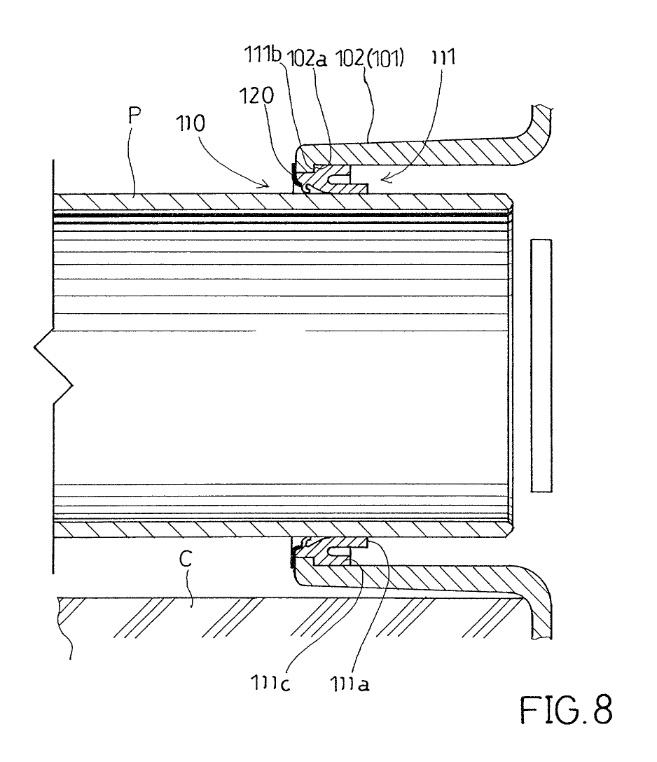

In the fourth embodiment shown in FIGS. 8 through 10, a drainside branch pipe P is illustrated as first connected pipe and a connection receiving inlet 102 of a drainpipe joint 101 is shown as a second connected pipe. A gasket 110 according to the present teachings is used to connect the side branch pipe P to the connection receiving inlet 102 of the pipe joint 101. The side branch pipe P is smaller in diameter than the connection receiving inlet 102, and as shown in FIG. 8, the gasket 110 is mounted between the outer peripheral side of the side branch pipe P and the opening inner peripheral side of the connection receiving inlet 102. Further, symbol C designates a concrete slab that partitions an upper floor from a lower floor in FIG. 8, and the vertical drainpipe joint 101 is constructed to vertically penetrate the concrete slab C.

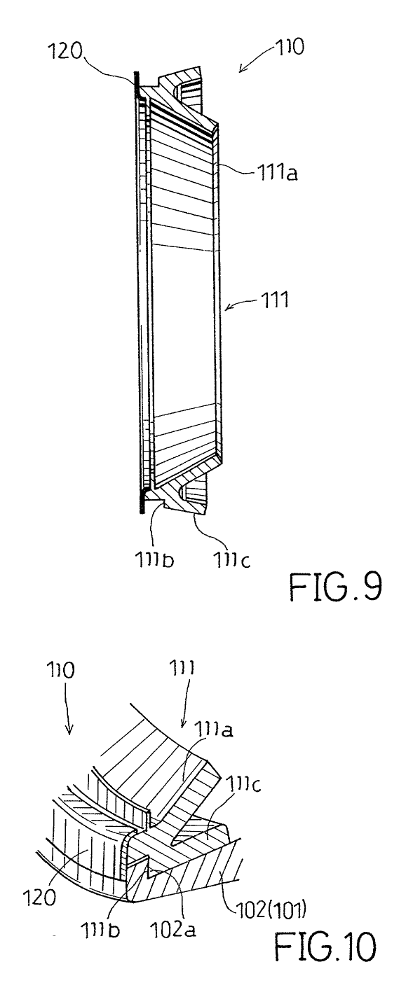

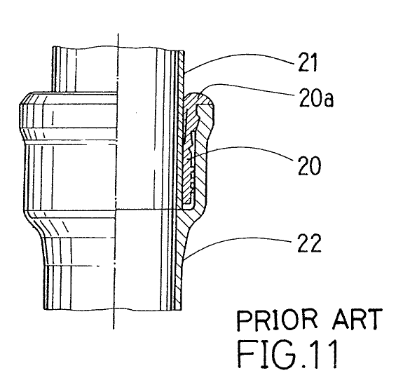

As shown in FIGS. 9 and 10, the gasket 110 of the fourth embodiment is comprised of a gasket body 111 that is made from rubber with proper elasticity and is monolithic-molded in a generally cylindrical shape. A reinforcing member 120 is attached on the end face of the gasket mounting rear end side (the left side as viewed in the figure). Reinforcing member 120 differs in shape from reinforcing member 3 in that reinforcing member 120 extends from the edge of the gasket 110 so as to abut and cover the connection receiving inlet 102. However, the function of reinforcing member 120 is similar or identical to reinforcing member 3 depending upon the pipe connection situation.

In an unmounted independent condition, the gasket 111 has a gradually tapered holding piece 111c with a increasing diameter toward the mounting front end side (the right side as viewed in the figure) as shown in FIG. 9, and a tapered seal piece 111a that is formed in an annular shape around the entire periphery of the inner peripheral side of a holding piece 111c with a decreasing diameter toward the mounting front end side. As shown in FIGS. 8 and 10, when the gasket 110 is mounted on the inner peripheral side of the connection receiving inlet 102, the holding piece 111c elastically presses against the inner peripheral surface of the connection receiving inlet 102, so that the gasket 110 is held in a prescribed mounted condition.

Also, as shown in FIG. 8, the seal piece 111a adheres to the outer peripheral surface of the side branch pipe P to provide a secure water-tight fit between the side branch pipe P and the connection receiving inlet 102. As mentioned above, because the seal piece 111a is gradually tapered, the side branch pipe P can be connected with a small inserting force. On the other hand, when the connected side branch pipe P is removed, a large removing force is required, because the seal piece 111a resists the removal of the side branch pipe P.

Further, on the outer peripheral surface of the gasket body 111, a stepped part 111b is formed around the entire periphery, which engages the stepped part 102a formed at the opening inner peripheral side of the connection receiving inlet 102 in the removal direction so as to prevent the gasket 110 from being removed when the side branch pipe P is removed. This feature is especially convenient when reconnecting the side branch pipe P after it has been removed for maintenance, for example.

Reinforcing member 120 can be attached to the end face at the mounting rear end side of the gasket body 111. The reinforcing member 120 preferably is made from a stainless steel sheet, has a ring shape and is attached to the gasket body 111 so as to project by a fixed amount from the mounting rear end face to the outer peripheral side of the gasket. The reinforcing member 120 can be firmly attached to the gasket body 111, for example, by means of the curling technique noted above.

As shown in FIG. 8, the reinforcing member 120 abuts the end face or terminal edge of the connection receiving inlet 102 when the gasket is mounted on the inner peripheral side of the connection receiving inlet 102. Therefore, when the side branch pipe P is inserted into the inner peripheral side of the gasket 110, the reinforcing member 120 (being made of a resilient material) does not easily deform, even if a large insertion force is exerted on the gasket body 110. Therefore, the insertion resistance of the side branch pipe P can be absorbed by the reinforcing member 120. Thus, the gasket 110 (gasket body 111) does not get forced inside the connection receiving inlet 102 together with the side branch pipe P. As a result, because the gasket 110 mounted on the connection receiving inlet 102 remains reliably fixed while the pipes are being connected, lubricants or other means to decrease insertion resistance are not required, as was the case with known gaskets. Therefore, the present gaskets are much more convenient to use.

The fourth embodiment described above can be modified in a variety of ways. For example, while a reinforcing member 120 made of a stainless steel sheet was described above, the reinforcing member 120 can be made from any rigid material that can endure the insertion resistance of a pipe, include such materials as, for example, carbon steel sheet or other metals, synthetic resins, woods, or ceramics.

Also, although the reinforcing member 120 was described as being attached to the gasket body 110 by means of a curling technique, other various means can be utilized to attach the reinforcing member. For example, the reinforcing member also can be firmly attached to the gasket body by adhesion, insert-molding, monolithic-molding or fastening with machine screws.

Further, though not illustrated, a buffer member formed of a rubber sheet in a ring shape can be disposed between the reinforcing member 120 and the end face of the connection receiving inlet 102, so that the occurrence of noise can be positively prevented when the reinforcing member 120 made from metal directly contacts the end face of the connection receiving inlet 120.

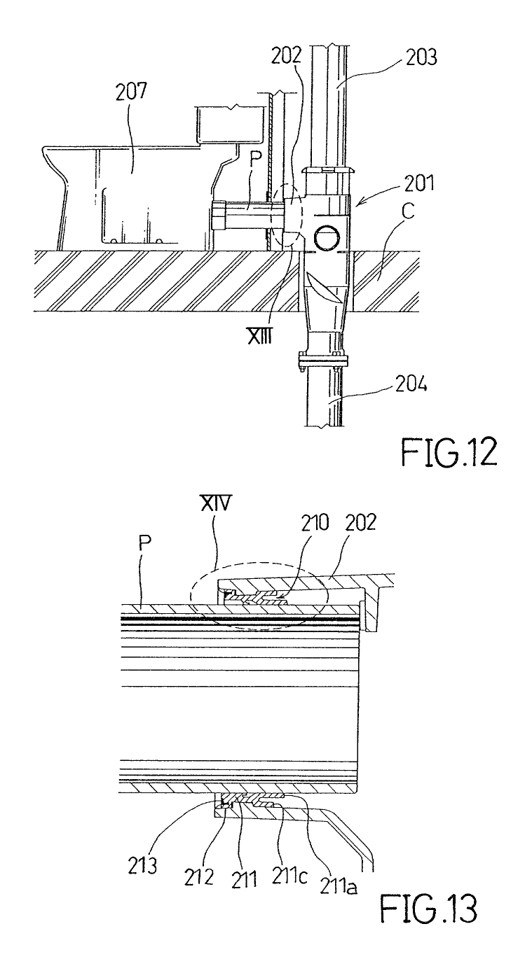

A fifth embodiment of the invention will now be described with reference to FIGS. 12 through 15. As shown in FIG. 12, also in the fifth embodiment, for purposes of description, a drainside branch pipe P is illustrated as one pipe to be connected, and as the second pipe to be connected, a connection receiving inlet 202 of a drainpipe joint 201 is illustrated. A gasket 210 of the present teachings is used to connect the side branch pipe P to the connection receiving inlet 202 of the pipe joint 201. As shown in FIG. 13, the side branch pipe P is smaller in diameter than the connection receiving inlet 202, and the gasket 210 is mounted between the outer peripheral side of the side branch pipe P and the inner peripheral side of the connection receiving inlet 202.

Moreover, in FIG. 12, numeral 207 is a toilet seat, which is connected to the pipe joint 201 via the side branch pipe P. Symbol C designates a concrete slab that partitions an upper floor from a lower floor and the vertical drainpipe joint 201 is constructed to vertically penetrate the concrete slab C. Numeral 203 is a vertical drainpipe at the upper stream side and numeral 204 is a vertical drainpipe at the downstream side.

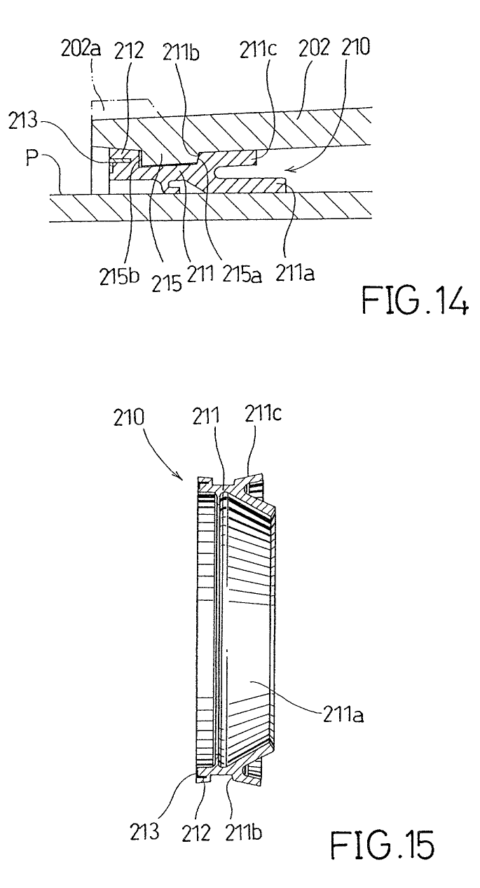

As shown in FIGS. 13 and 14, the gasket 210 of the fifth embodiment is comprised of a gasket body 211 that is made from rubber or other polymer material having appropriate elasticity for pipe connection operations and is monolithic-molded in a generally cylindrical shape. An insertion prevention edge 212 is preferably integrally formed with the mounting rear end side (the left side in the figures) of the gasket body 211 and a reinforcing member 213 for reinforcing the insertion prevention edge 212 can be provided.

As shown in FIG. 5, the gasket 211 has a gradually tapered holding piece 211c whose diameter becomes larger toward the mounting front end side (the right side as viewed in the figure) and a tapered seal piece 211a that is formed in an annular shape at the entire periphery of the inner peripheral side of the holding piece 211c and whose diameter becomes smaller toward the mounting front end side. As shown in FIGS. 13 and 14, when the gasket 210 is mounted on the inner peripheral side of the connection receiving inlet 202, the holding piece 211c elastically presses against the inner peripheral surface of the connection receiving inlet 202, so that the gasket 210 is held in the a prescribed mounted condition.

Also, as shown in FIGS. 13 and 14, the seal piece 211a adheres to the outer peripheral surface of the side branch pipe P to secure a water-tight fit between the side branch pipe P and the connection receiving inlet 202. As noted in the previous embodiments, because the seal piece 211a is tapered, the side branch pipe P can be connected with a small inserting force, while a large removing force is required to extract the connected side branch pipe P, because this seal piece 211a resists the removal of pipe P.

Further, on the outer peripheral surface of the gasket body 211, a stepped part 211b is formed around the entire periphery. This stepped part 211b can engage the second stepped part 215a at the inner side of the stepped part 215 formed at the opening inner peripheral side of the connection receiving inlet 202 in the removal direction so as to prevent gasket 210 from being removed from the connection receiving inlet 202 when side branch pipe P is removed. Gasket 210 will instead remain mounted inside connection receiving inlet 202, which is convenient for re-connecting the side branch pipe P.

An insertion prevention edge 212 is provided at the mounting rear end side of the gasket body 211 so as to project to the outer peripheral side. The insertion prevention edge 212 preferably is formed around the entire periphery of the gasket body 211 and the inside of the insertion prevention edge preferably is embedded with a metallic reinforcing member 213 that is ring shaped with an L-shaped cross-section. In the case of the fifth embodiment, the reinforcing member 213 can be inserted and embedded in the edge by monolithic-molding the gasket body 211 and the insertion prevention edge 212. The inclusion of the reinforcing member 213 increases the rigidity of the insertion prevention edge 212.

As shown in FIGS. 13 and 14, when the gasket is mounted on the inner peripheral side of the connection receiving inlet 202, the insertion prevention edge 212 abuts a first stepped part 215b at the opening side of a stepped part 215 formed on the inner peripheral surface of the connection receiving inlet 202. Therefore, when the side branch pipe P is inserted into the inner peripheral side of the gasket 210, even if the insertion resistance is applied to the gasket body 210, the insertion prevention edge 212 whose rigidity is increased by the metal reinforcing member 213 does not easily deform. Therefore, the insertion resistance of the side branch pipe P can be absorbed by the insertion prevention edge 212. As a result, the gasket 210 (the gasket body 211) does not get pushed inside of the connection receiving inlet 202 together with the side branch pipe P.

If stepped part 215 is provided on the inner peripheral surface of the connection receiving inlet, and thus the opening of the connection receiving inlet 202 becomes more narrow, and further if the rigidity of the opening of the connection receiving inlet 202 is reduced (as shown by a double-dashed line in FIG. 14), an annular reinforcing rib 202a can be formed at the opening outer peripheral side, so that the rigidity of the opening can be maintained.

As described above, because the gasket 210 mounted on the connection receiving inlet 202 does not get pushed into the inlet 202, lubricants or such other insertion resistance reducing means are not necessary. Thus, pipe connection operations are more convenient and less messy using such gaskets. Further, extra materials to clean off excess lubricant, such a soft cloth, are not necessary.

1. A pipe connecting gasket having a generally cylindrical shape and adapted to be mounted between two pipes when connecting a first pipe to a second pipe, wherein the gasket has a flange part at the periphery of the mounting rear end side that projects towards an outer peripheral side to abut a connection receiving inlet end face of the second pipe, and wherein a reinforcing member is disposed on the flange part.

2. A pipe connecting gasket as set forth in claim 1, wherein the gasket has a stepped part that can engage in a removal direction a corresponding stepped part provided on an inner peripheral surface of the connection receiving inlet of the second pipe.

3. A pipe connecting gasket as set forth in claim 1, wherein a folded part that projects to the mounting front end side and that can elastically engage the connection receiving end part of the second pipe extends from the outer periphery of the flange part, and the reinforcing member serves to prevent deformation of the flange part, the folded part, or both parts.

4. A pipe connecting gasket as set forth in claim 1, wherein a folded part that projects to the mounting front end side and that can elastically engage the connection receiving end part of the second pipe extends from the outer periphery of the flange part, and the reinforcing member is made from a nonflammable material and has an annular shape to cover the outer surfaces of the flange part and the folded part.

5. A pipe connecting gasket as set forth in claim 1, wherein a folded part that projects to the mounting front end side and that can elastically engage the connection receiving end part of the second pipe extends from the outer periphery of the flange part, the reinforcing member serves to prevent deformation of the flange part, the folded part, or both parts and wherein the reinforcing member is made from a nonflammable material and has an annular shape to cover the outer surfaces of the flange part and the folded part.

6. A pipe connecting gasket as set forth in claim 1, wherein the reinforcing member can be post-attached to the gasket after the gasket is mounted on the second pipe.

7. A pipe connecting gasket as set forth in claim 1, wherein a folded part that projects to the mounting front end side and that can elastically engage the connection receiving end part of the second pipe extends from the outer periphery of the flange part, the reinforcing member serves to prevent deformation of the flange part, the folded part, or both parts and the reinforcing member can be post-attached to the gasket after the gasket is mounted on the second pipe.

8. A pipe connecting gasket as set forth in claim 1, wherein the reinforcing member is pre-attached by means of insert-molding or monolithic-molding.

9. A pipe connecting gasket as set forth in claim 1, wherein a folded part that projects to the mounting front end side and that can elastically engage the connection receiving end part of the second pipe extends from the outer periphery of the flange part, and the reinforcing member for preventing deformation of the flange part, the folded part, or both parts is pre-attached by means of insert-molding or monolithic-molding.

10. A pipe connecting gasket as set forth in claim 1, wherein the reinforcing member is pre-attached by means of insert-molding or monolithic-molding and the reinforcing member is provided with an engaging part to latch the gasket.

11. A pipe connecting gasket as set forth in claim 1, wherein a folded part that projects to the mounting front end side and that can elastically engage the connection receiving end part of the second pipe extends from the outer periphery of the flange part, the reinforcing member for preventing deformation of the flange part, the folded part, or both parts is pre-attached by means of insert-molding or monolithic-molding and the reinforcing member is provided with an engaging part to prevent the gasket from being removed if the first pipe is removed from the second pipe.

12. A pipe connecting gasket as set forth in claim 1, wherein the reinforcing member is pre-attached by means of insert-molding or monolithic-molding and the reinforcing member is provided with an engaging part to prevent the gasket from being removed if the first pipe is removed from the second pipe.

13. A pipe connecting gasket as set forth in claim 1, wherein a folded part that projects to the mounting front end side and that can elastically engage the connection receiving end part of the second pipe extends from the outer periphery of the flange part, the reinforcing member for preventing deformation of the flange part, the folded part, or both parts is pre-attached by means of insert-molding or monolithic-molding and the reinforcing member is provided with an engaging part to prevent the gasket from being removed if the first pipe is removed from the second pipe.

14. A pipe connecting gasket having a generally cylindrical shape and adapted to be mounted between two pipes when inserting and connecting one pipe to another pipe, wherein the gasket has a flange part at the periphery of the mounting rear end side, which projects to the outer peripheral side to abut a connection receiving inlet end face of the second pipe, and wherein a folded part projects towards the mounting front end side around the outer periphery of the flange part, and can elastically engage the connection receiving end part of the second pipe.

15. A pipe connecting gasket as set forth in claim 14, wherein the gasket has a stepped part that engages in a removal direction a corresponding stepped part provided on the inner peripheral surface of the connection receiving inlet of the second pipe.

16. An attaching structure comprising the gasket as set forth in claim 1 and a connection receiving inlet of a pipe joint, wherein the flange part of the gasket is screwed onto the connection receiving inlet end face of the pipe joint.

17. An attaching structure comprising the gasket as set forth in claim 15 and a connection receiving inlet of a pipe joint, wherein the flange part of the gasket is screwed onto the connection receiving inlet end face of the pipe joint.

18. An attaching structure comprising the gasket as set forth in claim 15 and a connection receiving inlet of a pipe joint, wherein a stepped part to be fitted with the folded part is provided on the opening outer peripheral surface of the connection receiving inlet to suppress the projection of the folded part from the outer peripheral surface of the connection receiving inlet.

19. An attaching structure as set forth in claim 18, wherein the depth of the stepped part is made equal to or larger than the thickness of the folded part so that the folded part does not project from at least the outer peripheral surface of the connection receiving inlet.

20. An attaching structure comprising the gasket as set forth in claim 3 and a connection receiving inlet of a pipe joint, wherein a stepped part to be fitted with the folded part is provided on the opening outer peripheral surface of the connection receiving inlet to suppress the projection of the folded part from the outer peripheral surface of the connection receiving inlet.

21. An attaching structure of the pipe connecting gasket as set forth in claim 20, wherein the depth of the stepped part is made equal to or larger than the thickness of the folded part so that the folded part does not project from at least the outer peripheral surface of the connection receiving inlet.

22. A pipe connecting gasket having a generally cylindrical shape and adapted to be mounted between two pipes when inserting and connecting a first pipe to a second pipe, comprising a gasket body and a reinforcing member provided to project to the outer peripheral side of the mounting rear end side of the gasket body and to abut the connection receiving inlet end face of the second pipe so as to prevent the insertion of the gasket when inserting the first pipe into the second pipe.

23. A pipe connecting gasket as set forth in claim 22, wherein the reinforcing member is formed in a flange shape to project to the outer peripheral side at the entire periphery of the gasket body.

24. A pipe connecting gasket as set forth in claim 23, wherein a buffer member for preventing noise is inserted between the gasket and the connection receiving inlet end face, and wherein the reinforcing member is made to abut the connection receiving inlet end face.

25. A pipe connecting gasket as set forth in claim 22, wherein a buffer member for preventing noise is inserted between the gasket and the connection receiving inlet end face, and wherein the reinforcing member is made to abut the connection receiving inlet end face.

26. A pipe connecting gasket having a generally cylindrical shape and adapted to be inserted between two pipes when inserting and connecting a first pipe to a second pipe, wherein a gasket body has an integrally formed insertion prevention edge reinforced by a reinforcing member so as to project to the outer peripheral side, and wherein the insertion prevention edge abuts and engages a first stepped part provided at the inner peripheral side of the connection receiving inlet of the second pipe in an insertion direction.

27. A pipe connecting gasket as set forth in claim 26, wherein, on the outer peripheral surface of the gasket body, a removal prevention stepped part is provided to engage a second stepped part provided on the inner peripheral surface of the connection receiving inlet of the second pipe in a removal direction.

28. A gasket, comprising:
a gasket body having an annular shape and a tapered inner peripheral seal;
a flange portion extending outwardly from the gasket body at approximately a 90 degree angle and being annularly formed around the gasket body;
a folded portion projecting from the flange portion at approximately a 90 degree angle and the folded portion being annularly formed around the flange portion;
the gasket body, the flange portion and the folded portion being monolithically molded from a resin material and combining to form a channel to engage a connecting inlet of a pipe; and
a reinforcing member disposed on the flange and folded portions, the reinforcing member comprising a resilient material.

29. A gasket as in claim 28 further comprising a stepped portion formed on an outside periphery of the gasket body, the stepped portion having a shape that can engage a corresponding stepped portion in the connection inlet of the pipe.

30. A gasket as in claim 28 wherein the reinforcing member is removably attached to the flange portion and the folded portion.

31. A gasket as in claim 28 further comprising a tapered outer peripheral seal extending from an outer periphery of the gasket body.
